(19) United States
(12) Patent Application Publication
(10) Pub. No.: US 2010/0325245 A1
(43) Pub. Date: Dec. 23, 2010

(54) AGGREGATED PROXY BROWSER WITH AGGREGATED LINKS, SYSTEMS AND METHODS

(76) Inventor: Agostino Sibillo, Perris, CA (US)

Correspondence Address: FISH & ASSOCIATES, PC;ROBERT D. FISH, 2603 Main Street, Suite 1000, Irvine, CA, 92614-6232, US

(21) Appl. No.: 12/817,994

(22) Filed: Jun. 17, 2010

Related U.S. Application Data
(60) Provisional application No. 61/187,910, filed on Jun. 17, 2009.
(60) Provisional application No. 61/219,215, filed on Jun. 22, 2009.

(51) Int. Cl. G06F 15/16

(52) U.S. Cl. 709/219

(57) ABSTRACT

Systems and methods of aggregating on-line content into a context are presented. A context composer can define a context by defining one or more context attributes including network addresses of remote content and an arrangement of the content according to a desired presentation. The context can be managed as a distinct object separate from the content. The composer can also annotate the context as desired. The context can be assigned a single context network address, possibly directed to a context proxy server, which can be used request the context. Upon request, the server can instruct a requester's browser to render the context according to the composer's definition. Advertisements can be inserted into the context based on the context's defining attributes.

This application claims the benefit of priority to U.S. provisional application having Ser. No. 61/187,910 filed on Jun. 17, 2009, and claims the benefit of priority to U.S. provisional application having Ser. No. 61/219,215 filed on Jun. 22, 2009. These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is aggregated data access technologies.

### BACKGROUND

Current Internet browsing technologies allow individuals to access remote content using browser applications. Browsers have evolved from applications that simply render remote content into highly complex interfaces that can access on-line applications (e.g., Google Apps, games, etc.). However, users still generally browse a single content source at time using their browsers. Newer browsers have been adapted to allow users to browse multiple sources at the same time via a tabbed interface where each tab represents content obtained from a different source. Each link of a tab is treated individually outside of a desired context. Unfortunately, browser applications lack any means for defining a context in which content is viewed.

One of the many problems with browsing technologies is that a user must direct a browser to multiple sources via multiple links in order to put the content into a desired context. Such an approach is cumbersome and time consuming. Some effort has be put forth to allow users to arrange content as they like. For example, U.S. Pat. No. 7,702,635 to Horvitz et al. titled “System and Methods for Constructing Personalized Context-Sensitive Portal Pages or Views by Analyzing Patterns of Users' Information Access Activities”, filed Jul. 27, 2005, discusses forming a coalesced display or montage of aggregated information. In a similar vein, U.S. Pat. No. 7,725,530 to Sah et al. titled “Proxy Server Collection of Data for Module Incorporation into a Container Document”, filed Dec. 12, 2005, describes a system where proxy server can form a container page according to various formats.

Although users are able to define an arrangement of content for personal use, users still lack an ability to send a constructed context along with the content to another user. For example, International application publication WO 00/65773 to Cowden et al. titled “Portal System and Method”, filed Apr. 27, 2000, describes a system where a user can define a portal, through which the user can obtain data. Unfortunately, the user can not provide their portal definitions to others. If a first user wishes to send related content to a second user; the first user must send multiple links, possibly within an email, where each link points to each source of the content.

Ideally, a user should be able to arrange content from independent content sources in a desired arrangement to put the content into a desired context. The user should also be able to send a single link to a recipient through which the recipient can obtain the content within the desired context. When the recipient clicks on the link, the recipient's browser should present all the content within the same context as defined by the user, possibly through the use of a proxy browsing service.

Additional examples of previous effort put forth toward aggregating content and use of proxies include the following references.

U.S. Pat. No. 7,673,327 to Polis et al. titled “Aggregation System”, filed Jun. 27, 2007, describes a system for aggregating services.

U.S. Pat. No. 7,711,788 to Lev Ran et al. titled “Double-Proxy Remote Data Access System”, filed Jul. 26, 2007, discusses methods of obtaining access to a data resource via proxies.

U.S. patent publication 2010/0082431 to Ramer et al. titled “Contextual Mobile Content Placement on a Mobile Communication Facility”, filed Jun. 12, 2009, discusses receiving contextual information relating to a web request, associating the contextual information with mobile content, and finally displaying the mobile content to a user.

U.S. patent publication 2010/0100952 to Sample et al. titled “Network Aggregator”, filed Jan. 23, 2009, also describes an aggregation system that obtains data or services, which can be converted into an aggregatable form.

U.S. patent publication 2010/0125623 to Rice et al. titled “Cross-Domain Communication Technique for Execution of Web Mashups”, filed Nov. 18, 2008, discusses using a proxy server between a client computer and third party services to create a web mashup to avoid problems arising from a Same Origin Policy.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

What has yet to be appreciated is that a context can be defined (e.g., arrangement of content, tagged attributes of content, annotations, etc.) and presented to another user. The context can be associated with a single web-link referencing an intermediary aggregation proxy server. When a user clicks on the web-link, their browser is directed to the aggregation server, which in turn provides instructions to a browser to construct the context on the browser for the user. The aggregation server can obtain the context's content as a proxy browser where the content passes through the server to the browser. The content can then be presented in the browser in format according to the defined context. Furthermore, the outlined approach can be achieved using existing browser applications or technology without requiring modification to existing browser applications.

Thus, there is still a need for presenting a constructed context to a user.

### SUMMARY OF THE INVENTION

The inventive subject matter provides apparatus, systems and methods in which one can provide a context of content to other individuals. One aspect of the inventive subject matter includes a context aggregating proxy server. The system can include one or more intermediary context servers that are able to obtain content from remote, independent content sources; web servers for example. A user can access the context server via a context interface, preferably via a web page. The user supplies one or more context attributes that define a context where the attributes include at least an arrangement of content and content network addresses pointing to where the content can be obtained over a network. The system can further include a context manager that stores one or more defined contexts. When appropriate the context manager can also assign a network address, or other context identifier, to the context. The context network address can take on many different forms and preferably comprise a single URL by which a remote recipient can access the context. In especially preferred embodiments, the context network address represents a single link directed to the intermediary context server. In preferred embodiments, the context server responds to a browser request submitted to context network address by instructing the browser to present the content according to the arrangement of the context. Context network addresses can be sent by the context server, the user defining the context, or through other entities having authorized or authenticated access to the context. It is also contemplated that the context server could incorporate advertisements into the contexts, possibly based on the context's defining attributes.

Another aspect of the inventive subject matter can also include a method of aggregating via a proxy context server. Contemplated methods can include providing a context server that is capable of accessing remote, independent content sources (e.g., web servers) to obtain one or more content. The context server can be used to obtain a context definition from a remote user. The user can define a context by providing context attributes that at least include an arrangement of content and content network addresses that can be used to obtain the content from remote locations over a network. Another step of the contemplated method can include assigning a network address to the context (e.g., a URL, URI, GUID, etc.), and storing the context definition. Upon receiving a browser request directed to the context network address, the proxy context server can provide instructions to the requesting browser to reproduce the context according to the context definition. In some embodiments, the user can construct the context based on an a priori defined template, possibly having one or more content zones. Furthermore, the method can include obtaining an advertisement based on the context attributes (e.g., arrangement, relative positions, annotations, etc.), where the advertisement can be placed within one of the content zones.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic of an aggregating proxy server system.

FIG. 2 is a schematic of a context interface through a user can define a context of content.

FIG. 3 is a possible method for aggregating on-line data via a proxy.

### DETAILED DESCRIPTION

It should be noted that while the following description is drawn to a computer/server based context providing service, various alternative configurations are also deemed suitable and may employ various computing devices including servers, interfaces, systems, databases, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclose apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

One should appreciate that the disclosed techniques provide many advantageous technical effects including presenting a defined context to one or more remote individuals external to the proxy context servers.

The present inventive subject matter is drawn to systems, configurations, and methods of providing access to distributed content obtained from independent content sources, and to presenting the content within a defined context. A context is considered to represent a collection of content presented according to an arrangement (e.g., rules, instructions, programmatic code, etc.), where the context is treated as an object that comprises one or more defining attributes. Content is considered to include digital data that can be presented to a user, preferably through a browser application, the digital data can comprise images, video, audio, text, application data, web pages, blogs, feeds, streams, broadcast data, or other data that can be presented via a browser. The content can be presented, or otherwise rendered, according to the type of content. For example, the content can be presented by playing audio data, displaying images, playing video data, executing software instructions, or transforming the content data into format that is consumable by a browsing user.

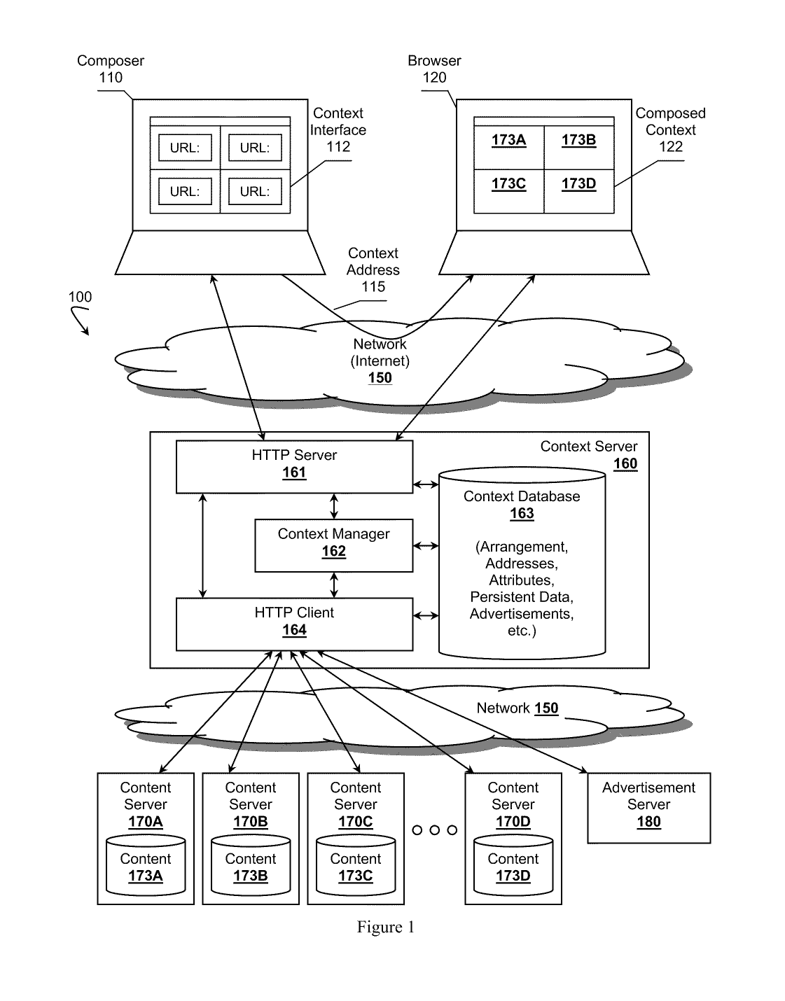

In FIG. 1, content aggregating proxy system 100 comprises an intermediary context server 160 positioned between browser 120 and content servers 170A through 170D, collectively referred to as content servers 170 (e.g., source of content). Context server 160 can operate as a proxy browser over network 150 for browser 120 and in response to context requests submitted by browser 120. Context server 160 can obtain content 173A through 173D, collectively referred to as content 173, when server 160 receives the context request. Server 160 provides content 173 to browser 120 and instructs browser 120 to present content 173 according to context 122 as defined by composer 110 via context interface 112.

Network 150 preferably comprises a packet switched network (e.g., LAN, WAN, Internet, etc.). It is also noted that any network 150 can be employed as long as network 150 can provides for data transport. In some especially contemplated embodiments, network 150 can include cell phone networks (e.g., CDMA, GSM, TDMA, etc.), where browser 120 can include a mobile device (e.g., PDA, game console, cell phone, camera, etc.).

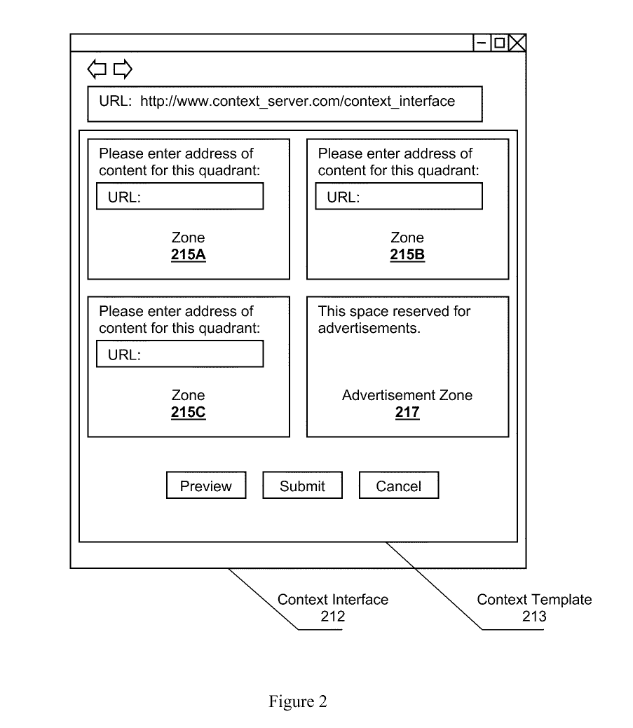

Composer 110 can represent a computer configured to communication with context server 160 via HTTP server 161, possibly through known HTTP communication methods. Composer 110 preferably comprises a browser application that renders context interface 112, through which an individual can define context 122 of any desired content located on remote servers 170. Additional information relating to context interface 112 is presented below with respect to FIG. 2.

Once a user is satisfied with context 122, a context address 115 is assigned to the context. The context network address 115 can be sent to a recipient located at browser 120. The recipient can instruct browser 120 to connect to context server 160 via context address 115. In response, context server 160 instructs browser 120 to display context 122.

One should appreciate that context 122 is considered to be an object of value and a separate distinct entity that can be managed separately from content 173. Context 122 has value because a first individual constructing a desired content arrangement wishes to communicate a complex idea to a recipient, where the idea or concept can not ordinarily be communicated by a single representation of content 173A through 173D. The context comprises a codified representation of one or more over arching themes. Therefore, context 122 can be leveraged as a valuable commodity for the individuals, for the recipient, for the service operating context server 160, or possibly others (e.g., advertisers, marketers, etc.).

Content servers 170 represent one or more remote, independently operated sources of content. Each of servers 170 can store its own content 173 and provide content 173 when it is requested at the content's network address.

As previously stated, context server 160 preferably operates an aggregating proxy browser. To support such a function, context server 160 can include HTTP server 161 that is responsive to composer 110 or browser 120. Server 160 can also include HTTP client 164 to obtain content 173 from servers 170 over network 150.

Additionally, context server 160 can comprise context manager 162. Context manager 162 is configured to manage contexts defined by one or more remote users. Once a context has been submitted, context manager 162 can store the context definition in context database 163. One should note that a context, context 122 for example, can be stored separately from the content referenced in the context. Context database 163 can utilize known techniques to store context information (e.g., Access, MySQL, Oracle, etc.) that aids in the definition of the context.

Context manager 162 not only manages a single context, but can manage many different contexts even when defined by different users. Therefore, management activities of manager 162 are also considered to include monitoring use of a context, inventorying content within a context, logging access to a context, reporting on activities associated with a context, providing alerts or notifications to context users, or providing secure access to the contexts. Security can be maintained by requiring a user to submit authentication or authorization information (e.g., password, RADIUS, Kerberos, OpeniD, keys, etc.).

Preferably context 122, or other context, is defined by one or more context attributes. In the example shown, context database 163 can store an arrangement of content, content addresses, user defined attributes (e.g., metadata, tags, ratings, etc), persistent data (e.g., browsing history, cookies, etc.), or other information. It is also contemplated that context database 163 can store advertisements that can be displayed within a context. Although only a few examples of context attributes are shown, all possible attributes are contemplated.

One type especially preferred context attribute includes a content arrangement. An arrangement can include information relating to the absolute position of content within context 122 or relative placement. The arrangement can also be a 2D representation, a 3D representation, or even a temporal representation where content is displayed according to a schedule similar to a slide show or play list.

Another type of preferred context attribute includes content identifier, more preferably content network addresses. As composer 110 constructs a desired content, URLs, or other network addresses, can be entered to identifying the location of content 173. Content identifiers can include URLs, URIs, GUIDs, API references, or other types of identifiers.

In some embodiments, context server 160 can also access advertisement server 180. When browser 120 requests a context, it is contemplated that context server 160, possibly via context manager 162, can request an advertisement from advertisement server 180 based on one or more of the requested context's attributes. Context server 160 can search for or request an advertisement having one or more properties that correlate to the context's attributes (e.g., related metadata, corresponding key words, correlated metrics, etc.).

FIG. 2 presents a schematic of a possible context interface 212 through which a user can define a context by entering one or more context attributes. The example provided is greatly simplified for clarity and can be rendered within a web browser as a web page hosted by a context server. It is contemplated that context interface 212 can be presented on nearly any computing device. For example, context interface 212 could be presented on a cell phone or could be presented as part of a social networking site.

Context interface 212 preferably offers the user an option for placing content into one or more of content zones 215A-215C, and 217, collectively referred to as content zones 215. It is also contemplated that one or more content zones could be reserved as an advertisement zone 217. Although four contents zones are presented, there can also be any number of content zones. For example, it is conceivable to have over 100 content zones.

In some embodiments, as illustrated, an arrangement of a context can be based on context template 213. Such an approach minimizes effort on the user's part to construct a context. When templates are employed, the templates can be a priori defined with a specific arrangement of content zones 215 or 217 (e.g., 2, 4, 6, 8, 10, 20, 100, or more zones).

Although context interface 212 illustrates a priori defined content zones 215, one should appreciate that zones 215 could be user defined as well. Additionally, it is contemplated that content zones 215 could be non-visible to hide content for restricted access or for playing non-visible content; audio data for example.

Once the user is satisfied with the context definition created through context interface 212, the user could preview their work, submit the context, reset the form, or otherwise manage their context. It is also contemplated the user to engage a context manager to manage the user's contexts. For example, the user can update a saved context, monitor use of the context, view context attribute or metrics, set permission levels, or otherwise manage contexts.

The simple example of FIG. 2 illustrates a minimal context interfere 212 where a user can only enter one or more content network addresses as context attributes. However, the Applicants contemplate that context interface 212 can be highly complex to accommodate the user entering various forms of context defining attributes.

In some embodiments a user can define their own content zones as discussed above. Context interface 212 can be configure to allow the user to drag-n-drop content into zones; configure size, shape, or other geometry of content zones; provide for overlapping content zones; schedule play times for content; or otherwise modify content zones 215 as desired. It is also contemplated that users can pay additional fees to override advertisement zone 217. It should be appreciated that the various content zone arrangements or geometries are considered content attributes.

In yet other embodiments, a user can include one or more rating scales as content attributes. Rating scales can include absolute scales (e.g., 1 to 10), relative scales (e.g., thumbs up or thumbs down), or even multiple valued scales (e.g., ratings for different types information).

In yet further embodiments, context interface 212 can also be configured to allow a user to enter metadata to be associated with the context. Metadata can be visible or non-visible as desired by the user. Metadata can be used to help classify the context or can be used to aid in selecting advertisements. It is also contemplated that a context manager can automatically tag a context with metadata. Example metadata can include time stamps, a context owner, permission levels, property-value pairs, metrics (e.g., number of views, time to live, etc.), geo-location or GPS information, topic, classification, sensor data relating to the composer's client device, or other types of information that can be used to define a context.

An especially preferred type of metadata includes annotations. A context can be annotated with various forms of additional data to allow a context composer to further clarify how the various forms of content relate to each other. For example, a user could graphically circle portions content in content zone 215A and draw an arrow to content in zone 215B. Annotations can take on different forms. Example annotations include audio annotations, graphic annotations, text annotations, real-time chat annotations, or other types of annotations. An astute reader will appreciate that real-time chat annotations imply that multiple individuals can annotate a context as desired, including the context recipient or the context composer.

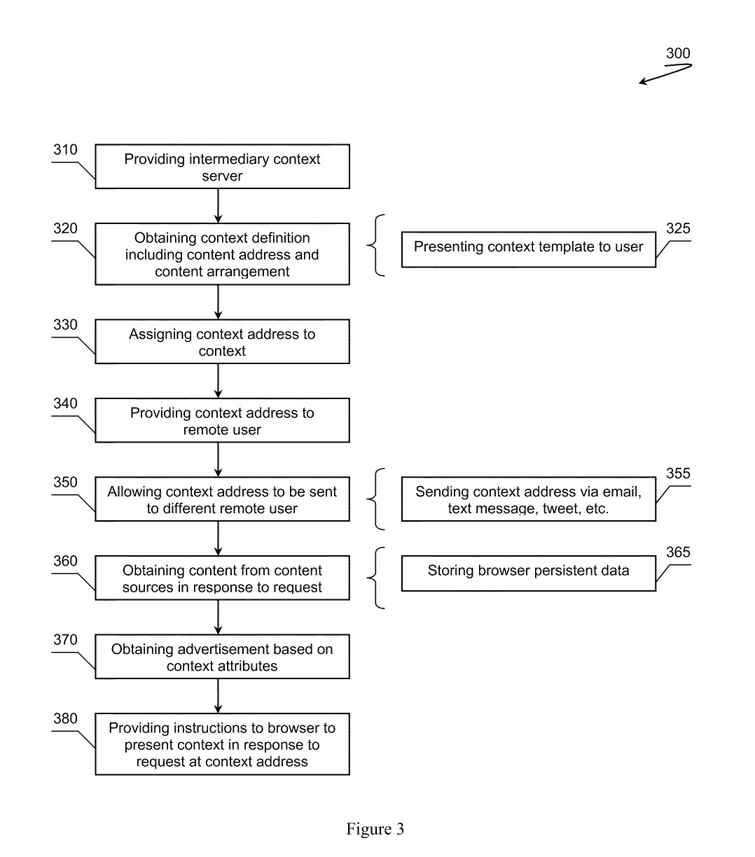

To provide additional clarity, FIG. 3 presents a possible method for aggregating on-line content via a proxy context server. In some embodiments, a proxy context server can be operated as a for-fee service to users, browsers, advertisers, or other entities that appreciate a context is a valuable commodity. An example system that can be used as part of the disclosed inventive subject matter includes those provided by Tarfoo™, Inc. The aggregated content can pass through the server and can be presented to a client device, preferably configured with browser functionality. In a preferred embodiment, client device presents the content according to the pre-defined context. Aggregated content can include web-based media (e.g., images, audio, applications, games, etc.) as well as locally hosted application data (e.g., documents, spreadsheets, presentations, etc.).

An initial step 310 can include providing an intermediary context proxy server. The content proxy server is preferably configured to obtain content from one or more remote, independent content sources, possibly web servers on the Internet. One should appreciate that the step of providing a server can be considered simply making a server available over a network, or installing suitable software on a server. In some embodiments, the proxy context server can be integrated with or within other types of Internet based services including social networking sites, possibly as a web service or other form of consumable web accessible API.

A user can define a context via a context interface preferably provided by a for-fee proxy aggregated browser service hosted on one or more servers. The user defines the context by selecting content, possibly via a web-link, and arranging the content as desired. The context can be considered a “view” of how the content should be rendered. The for-fee service can generate revenue through subscribers that pay for the ability to define contexts, fees for disabling advertisers, or payments from advertisers to place advertisements within contexts based on context attributes. For examples, advertisers could bid via an auction to gain the right to place advertisements based on context attributes including arrangements, metadata, identified theme, annotations, or other context attributes.

Step 320 is considered to include obtaining a context definition that defines a context in terms of one or more context attributes. Preferably the context definition includes content attributes that comprises at least content network addresses where content can be obtained over the network, and an arrangement of the content within the context. As discussed previously, a context composer or a context manager can bind additional attributes to a context as desired. Step 325 can further include the option of presenting a user a context template, possibly an a priori defined template, which the user can fill out to create a context or to annotate a context.

As discussed previously, a user can input one or more context attributes to define a context. Context attributes can include URLs, ratings, metadata, locations, time stamps, or other characteristics.

With respect to a context's arrangement, an arrangement of the content can include more content zones placed around a display of the browsing device. In some embodiments, the content zones can be rendered as a 2D representation or a 3D representation. In some embodiments, the content zones are presented as frames, or quadrants. It is also contemplated that the arrangement of content can include temporal aspects where a specified content is rendered for a period of time in a content zone then replaced by a different content. Preferably a context includes at least two or more content zones. It is thought that 2, 4, or 6 content zones would fit most uses. However, larger numbers of content zones are also contemplated (e.g., greater than 10, 20, 50 or even over 100 zones). One should note that content zones do not necessarily have to be visible, but could lack a visual representation. For example, a content zone could also include one or more audio channels, or even one or more data sockets used to accept application data.

Once a user is satisfied with a defined context, a web-link or other form of context network address can be associated with the context, where the link (e.g., IP address, URL, URI, web services API, etc.) references the proxy browsing service and identifies the context. For example, if the proxy context server is located at www.tarfoo.com, then a context might have a context address similar to www.tarfoo.com/context=<GUID> where GUID represents a unique identifier that points to the context.

Therefore, method 300 can comprise step 330, which includes assigning the defined context a context network address. The context network address preferably represents a single network location through which a browser can obtain access to the context, assuming proper authentication or authorization. Preferably the address reflects the address of the context server. The context network address can also include other information as desired to facilitate operation of the overall system. Additional information could include authorization codes, keys, advertising identifiers, permission levels, or other encoded data that can be used to aid in providing access to the context.

At step 340, once the context has an assigned network address, or other context identifier, the address can be provided to a user through various communication channels as desired. In some embodiments, a context manager generates the context network address and provides the context network address to the context composer. For example, upon submission of the context, the context manager can cause the context interface to present a URL to the composer by which others can access the context.

Step 350 further contemplates allowing the context address to be sent to other remote users, assuming proper authentication or authorization. Typically, it is expected that the context composer would provide the context network addresses to one or more desired recipients, possibly via email. The context manager allows the composer in the sense that no restrictions are placed on forwarding the context network address to one or more recipients. It is also expected that the context server can be configured to send the context network address. Step 355 suggests that a context network address can be sent through various communication channels including email, instant messaging, text message, twitter, social network blog posts, or other channels. Upon reception of the context network address, the recipient can simply click on the address to launch a browser, which in turn obtains the context and renders the image.

In some embodiments, at step 360 a context server can obtain content in response to receiving a context request from the recipient. The server can consult a context database to look up a context based on a context identifier associated with the context network address at which the context request was made. The server can obtain the context's defining attributes (e.g., arrangement data, metadata, content addresses, advertising information, etc.) from the context database in preparation for constructing the context on the recipient's browser. Furthermore, the server can determine the arrangement of the context by analyzing the context attributes including the geometry or format of the context arrangement. The step of obtaining the context could be performed before the context request arrives. Such an approach can be achieved through caching the content. In other embodiments the content is only obtained after a request for the context is received at the context network address (e.g., URL). One possible reason for waiting to obtain the content is to address temporal issues associated with the content to ensure the content is the most up to date version of the content. For example, a blog might have newer content that should be displayed over older content. In yet other embodiments where content is cached locally or remotely, the context could be constructed to represent a snap shot in time. One should appreciate that a context could also represent changes in a single set of content where each content zone provides a snap shot of the content at different times.

Step 365 further indicates a context server can store persistent data required to support proxy browsing on behalf of one or more recipients. For example, browser-based persistent data can be stored on a recipient by recipient basis. Example persistent data can include a browser history, cookies, authorization or authentication data, or other data. Storing persistent data provides for returning to a context at a later time, especially where persistent data is useful, possibly to support filing out forms, storing preferences to a remote site, remember purchasing information, or other purposes.

In some embodiments, the system can be configured to hide browsing history or cookies for security purposes. In other embodiments, the system can be configured to retain browsing history or cookies, where the retained information can be made available from the client browsing device or from the context server.

It is also contemplated advertisement data can be inserted into the context at step 370 by obtaining advertisements based on the context attributes. One should note that the context can be treated as a whole as opposed to individual contents. Therefore interesting information can be derived from the context as an object distinct from the content. Examples can include automatically identifying a unifying theme of the contest derived from the content, deriving a relative importance of each piece of content based on position, or other information. For example, if all the content in a context is related to a wedding, the server could determine through correlating keywords with concepts that the context pertains to marriage. The server can then provide advertisements for wedding goods or services.

The inventive subject matter is considered to include identification of advertisements that relate to a context based on the context's defining attributes. As mentioned briefly above, advertisements can be matched to a context based on the context's annotations, arrangement, theme, or other defining characteristics.

Advertising content can be integrated into a context based on the aggregation of content, the arrangement of the content in the context, or even based on how the context is shared. In some embodiments, advertising content can be integrated into the context based on the type of content data; video conferencing data, social networking data, news data, gaming data, or other types of data. In a preferred embodiment, an intermediary service hosted on one or more servers can track the number of impressions an advertisement has made based on the number of views of a context, the number of times a context has been shared, or other context attributes.

Step 380 includes providing instructions to a browser that requested the context. The instructions can include browser related codes or instructions possibly based on HTML, scripts, programmatic code, or other computer related control data. The server can automatically generate such instructions in real-time, the server could simply present the content within predefined template pages as desired, or the server can present the context using any other suitable known technique.

The rendering of the content can be prioritized based on user criteria, or other criteria. For example, the size or dimension of the content zone can be adjusted based on detected display device attributes, resources used, or other attributes. The content can be prioritized for rendering based on a user's preferences, on ratings of the content, on the number of views of the content, frequency of access, or yet other attributes. The context can be provided to a local browsing display (e.g., cell phone, computer, TV, etc.), where the context provides instructions to divide the display into content zones. The content zones could be frames, windows, quadrants, bitmaps mapped to rendered 3D surface, or other display objects. The content of the context can then be displayed in the various zones according to the context.

A context can also be presented to a user in a manner where the user can interact with the context as a whole as opposed to merely interacting with individual content. For example, a user could rate the context as a whole, or rank each of content elements relative to another. Another example includes sharing a context with other users, possibly in a chatting environment, in a social networking environment, in a gaming environment, in an advertising environment, or in other environments. All manner of interacting with a context as whole is contemplated.

In some embodiments, content within a context could conflict with other content. For example, if a context's content includes multiple audio data streams, it is preferred that only one of the audio data streams should be played at a given time. Conflicts can be resoled by based on one or more context attributes possibly including a proximity of a user's cursor in the context, frequency of access to the content, a rating of the content, zone location, annotations, user set priorities, or other attributes.

In some embodiments, a context can be configured to present content in a manner other than what was original intended. The content can be transformed from one modality to another before being presented to a context recipient. For example, rather than sending content as text data (e.g., HTML, etc.), the content can be pre-rendered as an image file where the image file is sent to the content recipient's display device. The image file could simply be a graphic image of what web page would ordinarily look like when properly rendered. The image would lack any of the original text data. Such an approach is thought to reduce the risk of an un-authorized third party eavesdropping on a browser session. Preferably, the rendered image file retains functionality of the original content, preferably through interaction with an intermediary proxy browser server.

Yet still another embodiment includes a distributed computing system where contexts can be used as an interface to a distributed computing infrastructure. A context server can aggregate application data from a plurality of independent application servers, possibly available over the Internet, where the application data represents content for a context. Preferably, an application context can be presented within a browser so that a user can access their computing environment from any browser enabled computer located anywhere there is network connectivity. The context could be considered a state of an application running within a cloud computing infrastructure where the state can be stored and restored from one computing session to another. It is specifically contemplated that a context could be presented as a web page within browser. It is also contemplated that a context could represent a web service that aggregates multiple web services. For example, multiple web service APIs can be aggregated and presented as a single API, or a transformed into a single, simplified web services API. In a preferred embodiment, an application context is managed by an intermediary data aggregation service operating between a client and the remote web-based computing infrastructure.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A content aggregating proxy system, the system comprising:
an intermediary context server configured to obtain content over a network from remote independent content sources;
an context interface through which a remote user supplies a plurality of content network addresses, each pointing to content located on one of the content sources, and through which the remote user specifies an arrangement of the content;
an context manager configured to store the arrangement and the content identifies as a context, and to assign a context network address to the context; and
wherein the intermediary context server is further configured to instruct a remote browser to present the content according to the arrangement in response to receiving a request at the context network address.

2. The system of claim 1, wherein the arrangement conforms to an a priori defined template.

3. The system of claim 2, wherein the template comprises at least four content zones.

4. The system of claim 1, wherein the intermediary context server obtains content for the context upon receiving the request at the context network address.

5. The system of claim 1, wherein the context manager is further configured to store browser-related persistent data associated with the content of the context.

6. The system of claim 1, wherein the context comprises an advertisement zone.

7. The system of claim 6, wherein the intermediary context server obtains advertisement data as a function of the context.

8. The system of claim 1, wherein the context network address uniquely identifies the context.

9. The system of claim 1, wherein the context manager is further configured to provide the context network address electronically to a second remote user.

10. The system of claim 1, wherein the remote content sources comprise cloud computing servers.

11. The system of claim 10, wherein the context comprises content representing application data from an application executing on the cloud computing infrastructure.

12. A method of aggregating on-line content via a proxy context server, the method comprising:
providing an intermediary context server capable of obtaining content over a network from remote independent content sources;
using the context server to obtain a context definition from a remote user, the context definition comprising a plurality of content network addresses, each pointing to content on one of the content sources, and the context definition comprising an arrangement of content;
assigning a context network address to a context based on the context definition and storing the context and context network address on the intermediary context server; and
providing instructions from the context server to a remote browser to display the content according to the arrangement of the context in response to the context server receiving a request at the context network address.

13. The method of claim 12, further comprising providing the remote user the context network address.

14. The method of claim 12, wherein the step of using the context server to obtain the context definition includes presenting the remote user an a priori defined template through which the remote user can enter the content network addresses.

15. The method of claim 12, further comprising the intermediary context server obtaining content from the plurality of content network addresses in response to receiving the request.

16. The method of claim 12, further comprising the intermediary context server storing browser related persistent data.

17. The method of claim 12, further comprising the intermediary context server obtaining an advertisement as a function of context attributes of the context and presenting the advertisement as part of the context.

18. The method of claim 17, wherein the context attributes comprises a relative arrangement of at least two portions of the context.

19. The method of claim 12, further comprising allowing the context network address to be sent to a second, different remote user.

20. The method of claim 19, further comprising the intermediary context server sending the context network address via at least one of the following: an email, a text message, and a tweet.
